(19) United States
(12) Patent Application Publication
(10) Pub. No.: US 2010/0050889 A1
(43) Pub. Date: Mar. 4, 2010

(54) Flexographic printing machine with a drying, desiccation , polymerization and/or heating device of the inked strip

(75) Inventors: Amerigo Manzini, Lecco (IT); Angelo Bartesaghi, Lecco (IT)

Correspondence Address: HEDMAN & COSTIGAN P.C., 1185 AVENUE OF THE AMERICAS, NEW YORK, NY, 10036, US

(73) Assignee: OMET S.r.I., LECCO (IT)

(21) Appl. No.: 12/308,534

(22) PCT Filed: Jun. 19, 2007
(86) PCT No.: PCT/IB2007/001698

§ 371 Date: Nov. 9, 2009

(30) Foreign Application Priority Data
Jun. 23, 2006 (IT) MI2006A001216

(51) Int. Cl. B41F 31/00

(52) U.S. Cl. 101/141

(57) ABSTRACT

Flexographic printing machine consisting of one or more printing stations (100) situated in series, each printing station (100) comprising a frame on which at least one cliché-holder cylinder (102) is assembled, suitable for applying ink, taken from a tank (104) by means of at least one inking cylinder (106) in contact with the cliché-holder (102) and rotating in an opposite direction with respect to this, on a continuous strip (108) of materials to be printed. The strip (108) is moved and kept in contact with the cliché-holder cylinder (102) by means of at least one counter-drum (110) which rotates in an opposite direction with respect to the cliché-holder cylinder (102). In correspondence with the counter-drum (110) downstream with respect to the cliché-holder cylinder (102), there are one or more devices (112) capable of drying, desiccating, polymerizing and/or heating the ink deposited on the strip (108) by the cliché-holder cylinder (102). The counter-drum (110) can be conditioned at a controlled temperature to absorb the heat possibly emitted from the drying, desiccation, polymerization and/or heating devices (112) of the ink.

The present invention relates to a flexographic printing machine equipped with a drying, desiccation, polymerization and/or heating device of the ink printed on the strip.

A well-known type of printing machine of the so-called flexographic type envisages the presence of one or more printing stations situated in series, each of which comprises a cliché-holder cylinder which, by resting on a so-called printing or counter-cylinder which rotates in the opposite direction with respect to the cliché-holder cylinder, transfers the inked imprint of the cliché onto a continuous strip of paper or other material fed between the above two cylinders.

The ink present on the cliché-holder cylinder is normally taken from a tank or equivalent element by means of a further cylinder, called anilox, in contact with the above cliché-holder cylinder and rotating in the opposite direction with respect to this. The surface of the anilox cylinder is produced with suitable materials and is provided with a series of very thin grooves so as to continuously remove the ink from the tank in a controlled manner and homogeneously transfer it to the cliché-holder cylinder and consequently onto the continuously moving strip.

In some of the more sophisticated flexographic printing machines and/or for particular printing requirements, downstream of the cliché-holder and counter-cylinders, there can be a drying, desiccation, polymerization and/or heating system of the inked strip, said system comprising one or more further rotating drums on whose surface the inked strip passes until it is conveniently dried, desiccated, polymerized and/or heated by one or more drying devices situated radially in correspondence with the rotating drum itself.

According to the types used, the drying device can consist for example of an ultraviolet-ray lamp or an infrared-ray lamp, an air-blowing device or other similar equipment, said device in any case being capable of heating or cooling the drum to dry the strip depending on the type of material to be printed, the processing required and the type of ink used.

One of the drawbacks that has been found in printing machines equipped with an additional heated and/or cooled drum, however, is linked to the necessity of differentiating the peripheral velocities of the various cylinders and rolls which move the strip, which, although having different diameters, must in any case guarantee a constant tension of the strip of material to be printed, regardless of its thickness and the material of which it is made.

An objective of the present invention is therefore to provide a flexographic printing machine equipped with a drying, desiccation, polymerization and/or heating device of the inked strip which allows the processing of materials to be printed having various thicknesses, without having to differentiate the peripheral velocities outside the material due to the presence of numerous rolls having a different diameter.

Another objective of the present invention is consequently to provide a flexographic printing machine equipped with a drying, desiccation, polymerization and/or heating device of the inked strip which is capable of both reducing the run of the strip itself between two adjacent printing stations and also reducing the scraps of material when the machine is activated.

Finally, a further objective of the present invention is to have a flexographic printing machine equipped with a drying, desiccation, polymerization and/or heating device of the inked strip which is particularly compact, with a reduced cost and easy maintenance.

These objectives according to the present invention are achieved by providing a flexographic printing machine equipped with a drying, desiccation, polymerization and/or heating device of the inked strip as specified in claim 1.

Further characteristics of the invention are indicated in the subsequent claims.

The characteristics and advantages of a flexographic printing machine equipped with a drying, desiccation, polymerization and/or heating device of the inked strip according to the present invention will appear more evident from the following illustrative and non-limiting description, referring to the enclosed schematic drawings, in which:

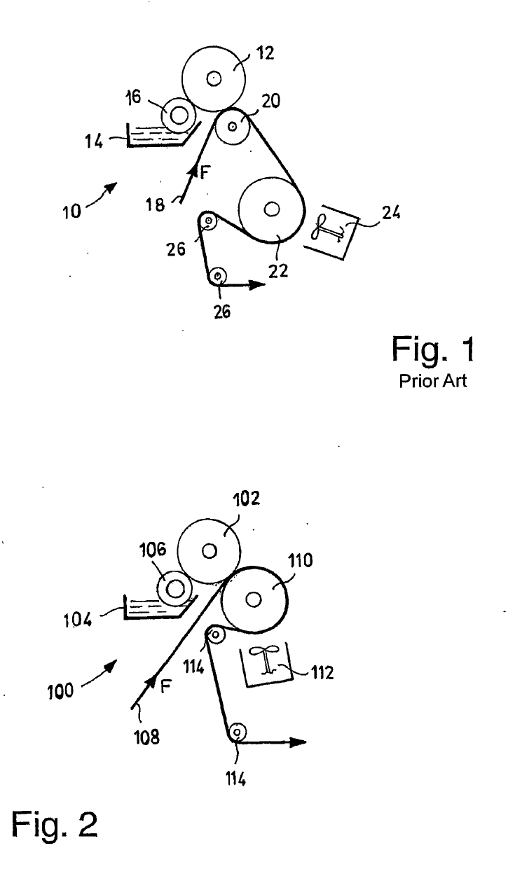

FIG. 1 is a completely schematic raised side view of a single printing station of a flexographic printing machine, equipped with a drying device of the inked strip, according to the known art; and

FIG. 2 is a completely schematic raised side view of a single printing station of a flexographic printing machine, equipped with a drying device of the inked strip, according to the present invention.

With reference to FIG. 1, this shows a completely schematic view of a single printing station belonging to a printing machine of the known type, indicated as a whole with the reference number 10.

The printing station 10 comprises a frame (not shown) on which a cliché-holder cylinder 12 is assembled, suitable for applying the ink, taken from a specific tank 14 by means of an inking cylinder 16 of the so-called “anilox” type in contact with the cylinder 12 and rotating in an opposite direction with respect to this, on a continuous strip 18 of paper or other material. The strip 18 is fed in the direction of the arrow F and is kept in contact with the cliché-holder cylinder 12 by means of a counter-cylinder 20 which rotates in the opposite direction with respect to said cliché-holder cylinder 12.

In machines of the known type such as that represented in FIG. 1, once the strip 18 has been inked, it reaches a drum 22 in correspondence with which there is a device 24, situated radially with respect to this, capable of drying the ink present on the strip 18. The drying device 24 can consist for example of one or more ultraviolet- or infrared-ray lamps, or an air blowing device, and is capable of heating and/or cooling the surface of the drum 22 to rapidly dry the ink 18, before this is sent, through one or more return rolls 26, towards the subsequent printing station or towards the outlet of the printing machine.

With reference to FIG. 2, this, on the other hand, shows a single printing station of a flexographic printing machine according to the present invention, indicated as a whole with the reference number 100.

Analogously to the printing machine according to the known art, described above, the printing station 100 comprises a frame (not shown) on which a cliché-holder cylinder 102 is assembled, suitable for applying the ink, again taken from a specific tank 104 or equivalent element, by means of an inking cylinder 106 in contact with the cylinder 102 and rotating in an opposite direction with respect to this, on a continuous strip 108 of paper or other material. Similarly, the strip 108 is fed in the direction of the arrow F and is kept in contact with the cliché-holder cylinder 102 by means of a counter-cylinder 110 which rotates in the opposite direction with respect to said cliché-holder cylinder 102.

Advantageously, according to the present invention, in correspondence with the contrast drum 110, there are one or more devices 112, situated radially with respect to this and downstream of the cliché-holder cylinder 102, capable of drying, desiccating, polymerizing and/or heating the ink deposited on the continuous strip 108 by the cliché-holder cylinder 102, said counter-drum 110 therefore also having the function of transporting and conditioning the strip 108. The counter-drum 110 can therefore be conditioned at a controlled temperature for absorbing the heated possibly emitted from the drying, desiccating, polymerization and/or heating devices 112.

Said drying devices 112 can consist, as in the printing machines of the known type, of ultraviolet-ray lamps, infrared-ray lamps or devices capable of blowing hot and/or cold air onto the strip wound around the drum 110. The temperature conditioning of the drum 110 allows it to be kept at a constant temperature, thus also contributing to keeping the tension of the material of which the strip is formed 108 constant, during its movement inside the printing machine.

In order to obtain a better conditioning degree of the temperature of the strip 108, it is conveniently almost completely wound around the drum 110 subjected to cooling and/or heating by means of the device 112, said strip 108 then being diverted by one or more return rolls 114 towards the subsequent printing station or towards the outlet of the printing machine.

It can thus be seen that the flexographic printing machine equipped with a drying device of the inked strip according to the present invention achieves the objectives specified above, in particular solving problems relating to the presence, in the known machines, of at least two rolls with independent functions, i.e. in contrast with the printing and drying cylinder of the continuous strip situated radially around the additional drum.

The fact of availing of a single driven roll capable of effecting both of the above functions does in fact allow strips having varying thicknesses to be processed without having to differentiate the peripheral velocities of the rolls which move the strips themselves, an operation which would be necessary in the presence of two driven rolls, with different diameters, suitable for conveying the strip to each printing station.

Furthermore, the printing machine according to the present invention is particularly compact, consequently facilitating the work of the operators surveying the various printing stations which form the machine itself.

The flexographic printing machine with a drying device of the inked strip of the present invention thus conceived can in any case undergo numerous modifications and variants all included in the same inventive concept.

Furthermore, in practice, the material used as also the dimensions and components can vary according to technical requirements.

1. A flexographic printing machine consisting of one or more printing stations (100) situated in series, each printing station (100) comprising a frame on which at least one cliché-holder cylinder (102) is assembled, suitable for applying ink, taken from a tank (104) by means of at least one inking cylinder (106) in contact with said cliché-holder (102) and rotating in an opposite direction with respect to this, on a continuous strip (108) of materials to be printed, said strip (108) being moved and kept in contact with said cliché-holder cylinder (102) by means of at least one counter-drum (110) which rotates in an opposite direction with respect to said cliché-holder cylinder (102), characterized in that in correspondence with said counter-drum (110), downstream with respect to said cliché-holder cylinder (102), there are one or more devices (112) capable of drying, desiccating, polymerizing and/or heating the ink deposited on said strip (108) by said cliché-holder cylinder (102), said counter-drum (110) possibly being conditioned at a controlled temperature to absorb the heat possibly emitted from said drying, desiccation, polymerization and/or heating devices (112) of the ink.

2. The flexographic printing machine according to claim 1, characterized in that said one or more drying, desiccation, polymerization and/or heating devices (112) of the ink comprise ultraviolet- and/or ultrared-ray lamps.

3. The flexographic printing machine according to claim 1, characterized in that said one or more drying, desiccation, polymerization and/or heating devices (112) of the ink comprise devices capable of blowing hot and/or cold air onto said drum (110).

4. The flexographic printing machine according to one of the previous claims, characterized in that said strip (108) is almost completely wound onto said drum (110) subjected to cooling and/or heating to obtain the best temperature conditioning degree of said strip (108).

5. A flexographic printing machine with a drying, desiccation, polymerization and/or heating device of the inked strip as previously described and illustrated and for the purposes specified above.
